(19) United States
(12) Patent Application Publication
(10) Pub. No.: US 2012/0251734 A1
(43) Pub. Date: Oct. 4, 2012

(54) DRYING DEVICE

(76) Inventor: Nobuyuki Yamazaki, Toyota-shi (JP)

(21) Appl. No.: 13/515,312

(22) PCT Filed: Dec. 6, 2010
(86) PCT No.: PCT/IB10/03108

§ 371 Date: Jun. 12, 2012

(30) Foreign Application Priority Data
Dec. 18, 2009 (JP) 2009-288254

(51) Int. Cl. F26B 15/00; B05D 5/12; B05D 3/12

(52) U.S. Cl. 427/541; 34/611

(57) ABSTRACT

A drying device (10) includes: a drying furnace (12); a plurality of guide rollers (14) that are arranged in the drying furnace (12) and that transport a sheet-like current collector (210); and a vibration imparting device (16) that is provided for at least part (14a) of the plurality of guide rollers (14) arranged in the drying furnace (12) and that imparts vibrations to the at least part (14a) of the plurality of guide rollers (14).

### BACKGROUND OF THE INVENTION

1. Field of the Invention

The invention relates to a drying device and, more particularly, to a drying device that, for example, dries electrode slurry applied to a current collector.

2. Description of the Related Art

An electrode sheet having a coating (material mixture layer) that is formed by drying electrode slurry applied to a sheet-like current collector may be used as an electrode for a secondary battery. In a manufacturing process of the electrode sheet, an electrode active material dispersed and dissolved in the electrode slurry may settle out or migration may occur inside the coating during drying. As a result, a coating may be formed to have a large amount of binders at an interface portion to air and a reduced amount of binders at a boundary portion with the current collector. When a coating having a reduced amount of binders is formed at the boundary portion with the current collector, the coating that contains the electrode active material easily peels off from the electrode sheet.

In contrast, Japanese Patent Application Publication No. 9-134718 (JP-A-9-134718) describes that electrode slurry is applied and dried in two or more sets of application process and drying process to form a coating having a predetermined thickness on a current collector.

In addition, Japanese Patent Application Publication No. 2005-050755 (JP-A-2005-050755) describes that a plurality of types of electrode slurry having different concentrations of solid content are prepared and are applied to a current collector so that the concentration of solid content (electrode active material, conductive material and binder) sequentially increases from the surface of a coating toward the current collector to thereby laminate a plurality of thin film layers having different concentrations of content.

In addition, Japanese Patent Application Publication No. 2003-109598 (JP-A-2003-109598) describes that a binder having a grain size distribution is used for electrode slurry. By so doing, portions of electrode active material easily closely adhere to each other through the binder, so an electrode having a high adhesion strength may be obtained.

In addition, Japanese Patent Application Publication No. 2006-54096 (JP-A-2006-54096) describes a technique that uses lithium secondary battery electrode slurry that contains, as a binder, carboxymethylcellulose (CMC) and a nonaqueous binder and that further contains a water-soluble organic compound having a boiling point of 150° C. or above. Then, the lithium secondary battery electrode slurry is applied onto a current collector, and is then dried under a drying condition that the vapor rate of water and a water-soluble organic compound until they reach a dry-to-touch state regulated by JISK5500 is set to 100 g/minute or higher on an average per square meter of one side of the current collector.

Incidentally, as one of methods for increasing the production efficiency of a battery, in a drying process subsequent to application of electrode slurry to a current collector, it is conceivable that the electrode slurry is rapidly exposed to a high-temperature atmosphere to be dried in a short period of time. However, when the electrode slurry is rapidly exposed to a high-temperature atmosphere to be died in a short period of time, migration or concentration diffusion occurs in the electrode slurry applied to the current collector, so the binder in the electrode slurry tends to move to an upper layer of the electrode slurry. In contrast, as is described in JP-A-9-134718, when the electrode slurry is applied for coating in two or more sets of application process and drying process, it takes a long manufacturing time, so production cost increases. In addition, in the method described in JP-A-2005-050755, preparation of the electrode slurry is complicated. In addition, in the method described in JP-A-2003-109598 or the method described in JP-A-2006-54096, the material of the electrode slurry is restricted.

### SUMMARY OF INVENTION

The invention provides a new method that is able to reduce the influence of migration or concentration diffusion that occurs in electrode slurry applied to a current collector in a drying process.

A first aspect of the invention provides a drying device. The drying device includes: a drying furnace; a plurality of guide rollers that are arranged in the drying furnace and that transport a sheet-like current collector; and a vibration imparting device that is provided for at least part of the plurality of guide rollers arranged in the drying furnace and that imparts vibrations to the at least part of the plurality of guide rollers. With the above drying device, in the process of drying the electrode slurry applied to the current collector, it is possible to suppress occurrence of migration or concentration diffusion in the electrode slurry.

In this case, the vibration imparting device may, for example, impart vibrations of 15 kHz or above to the at least part of the plurality of guide rollers. In addition, the vibration imparting device may be provided for part of the plurality of guide rollers provided in a first half region within a region in which the sheet-like current collector is dried in the drying furnace. In addition, the vibration imparting device may include a vibrator, each guide roller may have a fixed shaft and a rolling shaft that is assembled to the fixed shaft via a bearing, and the vibrator may be attached to the fixed shaft.

A second aspect of the invention provides a guide roller equipped with a vibration imparting device. The guide roller includes a fixed shaft and a rolling shaft that is assembled to the fixed shaft via a bearing, wherein a vibrator is attached to the fixed shaft. In the guide roller, vibrations are imparted from the vibrator to the rolling shaft via the fixed shaft and the bearing. The fixed shaft is fixedly arranged, so wiring to the vibrator is easy. Thus, it is possible to appropriately impart vibrations to the rolling shaft that transports the current collector. The guide roller equipped with the vibration imparting device may be suitably used for the drying device according to the aspect of the invention.

A third aspect of the invention provides a manufacturing method for an electrode sheet in which a coating that contains an electrode active material is formed on a sheet-like current collector. The manufacturing method includes: an electrode slurry application step of applying electrode slurry containing the electrode active material to the sheet-like current collector; and a drying step of drying the electrode slurry while imparting vibrations to the current collector to which the electrode slurry is applied in the electrode slurry application step. With the above manufacturing method for an electrode sheet, in the process of drying the electrode slurry applied to the current collector, it is possible to suppress occurrence of migration or concentration diffusion in the electrode slurry.

### BRIEF DESCRIPTION OF DRAWINGS

The features, advantages, and technical and industrial significance of this invention will be described below with reference to the accompanying drawings, in which like numerals denote like elements, and wherein:

FIG. 1 is a view that shows a drying device according to an embodiment of the invention;

FIG. 2 is a view that shows an electrode slurry coating apparatus that includes the drying device according to the embodiment of the invention;

FIG. 3 is a partially cross-sectional view that shows the structure of a guide roller according to the embodiment of the invention;

FIG. 4A, FIG. 4B and FIG. 4C are views that show the behavior of particles in electrode slurry in a drying process according to a related art;

FIG. 5A and FIG. 5B are views that show the behavior of particles in electrode slurry in a drying process;

FIG. 6 is a view that shows a configuration example of a lithium ion secondary battery;

FIG. 7 is a view that shows a rolled electrode assembly of the lithium ion secondary battery;

FIG. 8 is a cross-sectional view that shows the structure of the rolled electrode assembly of the lithium ion secondary battery; and

FIG. 9 is a view that shows a vehicle equipped with the lithium ion secondary battery.

### DETAILED DESCRIPTION OF EMBODIMENTS

Hereinafter, a drying device according to an embodiment of the invention will be described. Note that the aspect of the invention is not limited to the embodiment described below. In addition, like reference numerals denote members and portions having similar functions where appropriate.

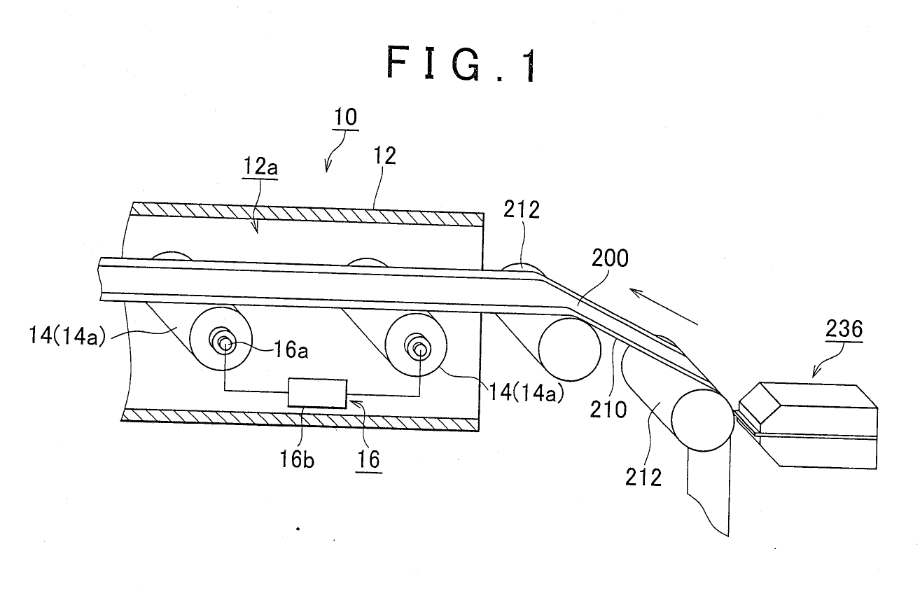

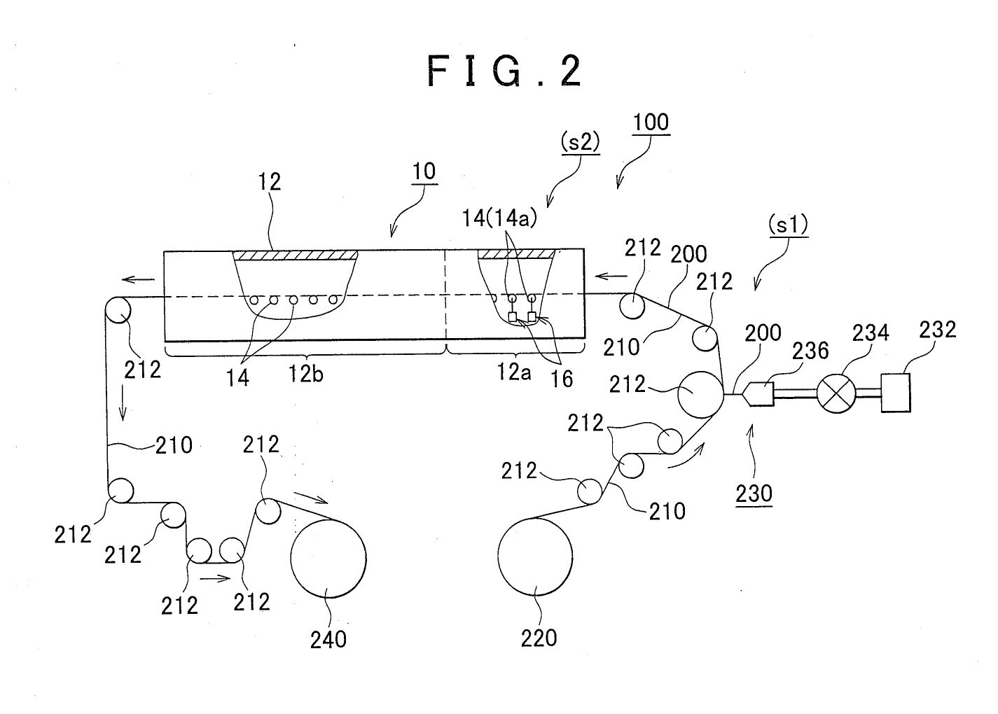

As shown in FIG. 1, the drying device 10 according to the embodiment includes a drying furnace 12, guide rollers 14 and vibration imparting devices 16. In the present embodiment, the drying device 10 is a device for drying electrode slurry 200 applied to a sheet-like current collector 210. As shown in FIG. 2, the drying device 10 is, for example, used for an electrode slurry coating apparatus 100. The electrode slurry coating apparatus 100 carries out a series of processes in which the electrode slurry 200 is applied to the sheet-like current collector 210 and the electrode slurry 200 is dried. In the example shown in FIG. 2, the current collector 210 is transported along a transport path that passes along a plurality of guide rollers 212 sequentially from a feed roll 220 through an electrode slurry application device 230 and the drying device 10 to a take-up roll 240.

The electrode slurry application device 230 is a device that applies the electrode slurry 200 to the current collector 210. In the present embodiment, the electrode slurry application device 230 includes a tank 232, a pump 234 and a die 236. The tank 232 stores the electrode slurry 200 that is prepared from an electrode active material, a conductive material and a binder. The pump 234 is a device that supplies the electrode slurry 200, stored in the tank 232, to the die 236. The die 236 discharges the electrode slurry 200, supplied from the pump 234, to the current collector 210.

The drying furnace 12 is a furnace that creates a drying atmosphere for drying the electrode slurry 200 applied to the sheet-like current collector 210. The drying furnace 12 has a transport path that allows the foil-like current collector 210 to be passed therethrough. In the present embodiment, the drying furnace 12 includes a preliminary drying portion 12a and a regular drying portion 12b. The preliminary drying portion 12a is provided at the first half of the transport path. The regular drying portion 12b is provided at the second half of the transport path. The preliminary drying portion 12a is set at a temperature lower than that of the regular drying portion 12b. The preliminary drying portion 12a is, for example, set at the first half of the drying process to a low-temperature atmosphere such that migration may be suppressed to a lesser degree. The regular drying portion 12b is set subsequently to the preliminary drying process to a high-temperature atmosphere such that the electrode slurry 200 may be dried to a desired state.

The drying furnace 12 includes the guide rollers 14 and the vibration imparting devices 16. The guide rollers 14 guide the sheet-like current collector 210. The plurality of guide rollers 14 are arranged in the drying furnace 12 along the transport path set inside the drying furnace 12. In the present embodiment, the vibration imparting devices 16 each are a device that imparts vibrations to a corresponding one of the guide rollers 14, and each are provided for a corresponding one of the plurality of guide rollers 14 arranged in the drying furnace 12.

The vibration imparting device 16 is provided for each of part of the guide rollers 14 (guide rollers 14a), which are arranged at the preliminary drying portion 12a, among the plurality of guide rollers 14 arranged in the drying furnace 12. Each vibration imparting device 16, for example, includes a vibrator 16a and an actuator 16b that actuates the vibrator 16a.

The vibrator 16a is a vibration generating element that imparts vibrations to the corresponding guide roller 14. The vibrator 16a may be, for example, a Langevin vibrator. The actuator 16b is a device that causes the vibrator 16a to vibrate. The actuator 16b applies high-frequency voltage to the driving terminal of the Langevin vibrator as the vibrator 16a. The Langevin vibrator is used as the vibrator 16a, and the oscillatory frequency of the vibrator 16a may be controlled by the actuator 16b. The frequency applied to the vibrator 16a is arbitrarily regulated between 15 kHz to 80 kHz. The vibrator 16a is able to vibrate at a frequency of ultrasonic level.

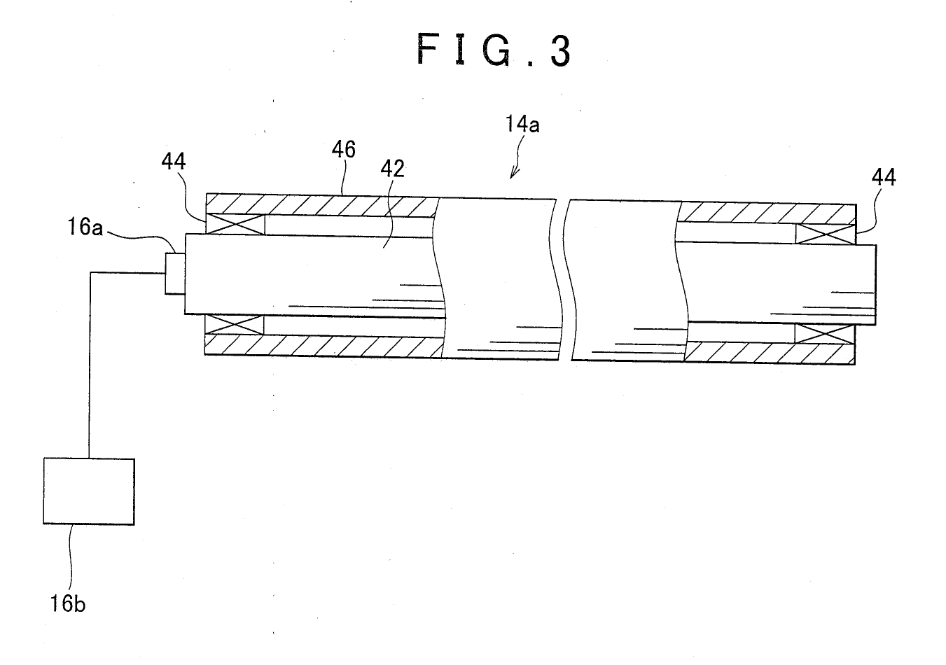

As shown in FIG. 3, each guide roller 14a equipped with the vibration imparting device 16 includes a fixed shaft 42, bearings 44 and a rolling shaft 46. The fixed shaft 42 is a shaft arranged along the central axis of the guide roller 14a. The bearings 44 (in the present embodiment, radial bearings) are provided at both axial end portions of the fixed shaft 42. The rolling shaft 46 is rollably provided around the outer periphery of the fixed shaft 42 via the bearings 44. Although not shown in the drawing, each guide roller 14a is attached to the drying furnace 12 via the fixed shaft 42. In addition, the vibrator 16a of the vibration imparting device 16 is attached to the fixed shaft 42, and transfers vibrations to the rolling shaft 46 through the fixed shaft 42 and the bearings 44.

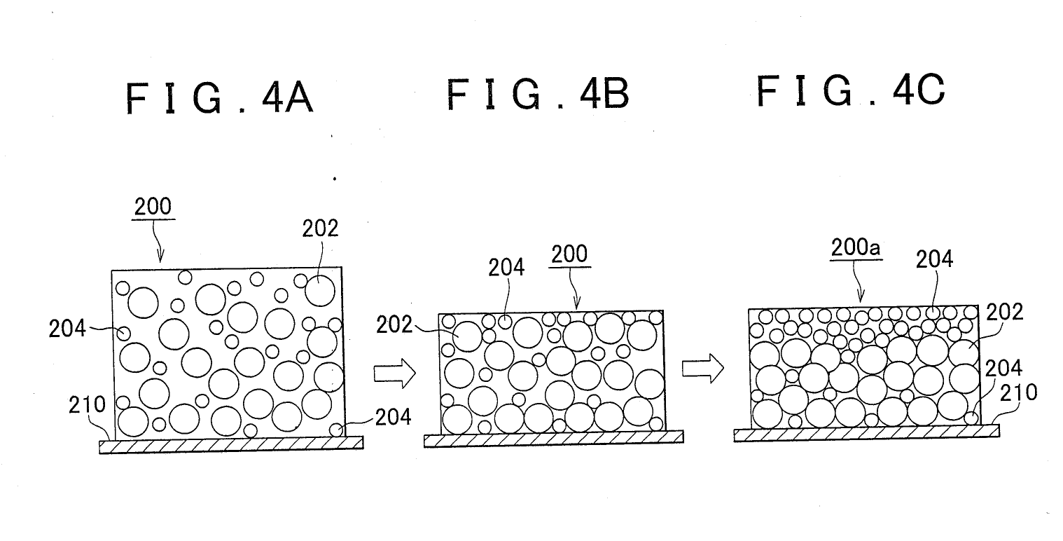

The preliminary drying portion 12a of the drying furnace 12 is regulated to a drying atmosphere having a temperature lower than that of the regular drying portion 12b but higher than that of an ambient atmosphere. The electrode slurry 200 applied to the current collector 210 gradually dries out at the preliminary drying portion 12a. At this time, as the electrode slurry 200 applied to the current collector 210 enters the drying furnace 12, the electrode slurry 200 is rapidly exposed to a high-temperature atmosphere. When no vibration imparting device 16 is provided, migration or concentration diffusion occurs in the electrode slurry 200 applied to the current collector 210. In this case, for example, as shown in FIG. 4A to FIG. 4C, the electrode active material 202 in the electrode slurry 200 settles out, and the binder 204 in the electrode slurry 200 moves to the upper layer of the electrode slurry 200. By so doing, as shown in FIG. 4C, in the coating 200a that is formed of the dried electrode slurry 200, the binder 204 reduces at the boundary portion with the current collector 210.

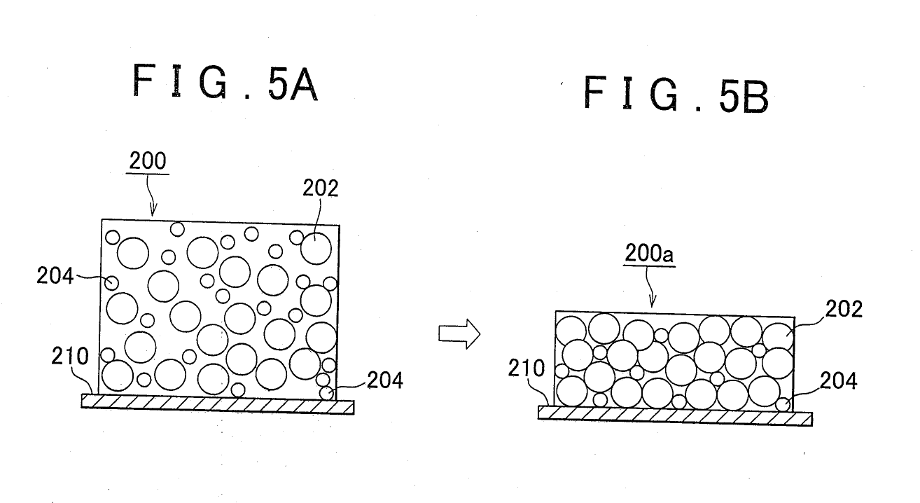

In contrast, in the present embodiment, as shown in FIG. 1 and FIG. 2, in the drying furnace 12, the vibration imparting device 16 is provided for each of the guide rollers 14a arranged at the preliminary drying portion 12a. Each guide roller 14a vibrates at a frequency of ultrasonic level, and imparts vibrations to the current collector 210 transported by the guide roller 14a. As shown in FIG. 5A and FIG. 5B, the current collector 210, to which vibrations are imparted by the guide rollers 14a, transfers vibrations to the electrode slurry 200 applied to the current collector 210. By so doing, vibrations are transferred to particles in the electrode slurry 200. Vibrations are transferred to the particles of the electrode slurry, and the particles move in arbitrary directions. Therefore, for example, as shown in FIG. 5A and FIG. 5B, it is possible to prevent the electrode active material 202 in the electrode slurry 200 from settling out or the binder 204 in the electrode slurry 200 from moving to the upper layer of the electrode slurry 200. By so doing, it is possible to prevent reduction of the binder 204 at the boundary portion with the current collector 210 in the coating 200a that is formed of the dried electrode slurry 200.

In this way, in the present embodiment, the vibration imparting device 16 that imparts vibrations to the corresponding guide roller 14a is provided for at least part of the guide rollers 14 (guide rollers 14a) arranged in the drying furnace 12. Therefore, vibrations may be imparted to the current collector 210 transported inside the drying furnace 12. By so doing, it is possible to prevent the electrode active material 202 in the electrode slurry 200 from settling out or the binder 204 in the electrode slurry 200 from moving to the upper layer of the electrode slurry 200.

At the preliminary drying portion 12a, it is only necessary that the electrode slurry 200 is dried to an extent that movement of particles in the electrode slurry 200 is restricted. At the subsequent regular drying portion 12b, the current collector 210 is exposed to a high-temperature atmosphere; however, particles in the electrode slurry 200 do not move. By so doing, as shown in FIG. 5B, in the coating 200a formed of the dried electrode slurry 200, it is possible to prevent reduction in the binder 204 at the boundary portion with the current collector 210, so the coating 200a is hard to peel off from the current collector 210.

In addition, in the present embodiment, in the drying furnace 12, the vibration imparting device 16 is provided for each of the guide rollers 14a arranged at the preliminary drying portion 12a. Then, at the preliminary drying portion 12a, it is possible to dry the electrode slurry 200 while imparting vibrations to the current collector 210 to which the electrode slurry 200 is applied. Therefore, at the preliminary drying portion 12a, movement of particles in the electrode slurry 200 is suppressed to a lesser degree. Therefore, even when a high-temperature atmosphere is set for the preliminary drying portion 12a, it is possible to prevent the electrode active material 202 from settling out or the binder 204 in the electrode slurry 200 from moving to the upper layer of the electrode slurry 200. By so doing, a high-temperature atmosphere may be set for the preliminary drying portion 12a in the drying furnace 12, and the electrode slurry 200 may be dried in a further short period of time, so the productivity of an electrode sheet may be improved.

Note that, in the present embodiment, the drying furnace 12 is divided into the preliminary drying portion 12a and the regular drying portion 12b; however, the aspect of the invention is not limited to this configuration. The drying furnace may have a constant temperature overall, or may be configured so that the temperature gradually increases from the upstream side of the transport path that allows the current collector 210 to pass therethrough toward the downstream side of the transport path.

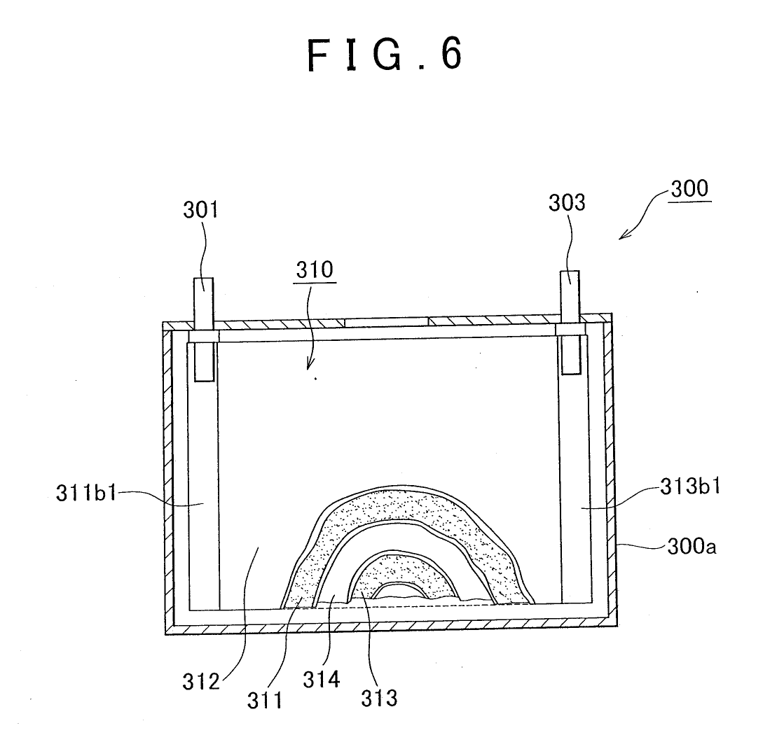

When the drying device 10 is used, it is possible to suppress migration or concentration diffusion in the drying process for the electrode slurry 200 applied to the current collector 210. Therefore, it is possible to prevent the electrode active material 202 in the electrode slurry 200 from settling out or the binder 204 in the electrode slurry 200 from moving to the upper layer of the electrode slurry 200. Therefore, it is possible to manufacture an electrode sheet in which the coating 200a applied to the current collector 210 is hard to peel off. The electrode sheet in which the electrode slurry 200 is applied to the current collector 210 is, for example, used for a lithium ion secondary battery 300 shown in FIG. 6. FIG. 6 shows the schematic configuration of the lithium ion secondary battery 300 that uses the electrode sheet in which the electrode slurry 200 is applied to the current collector 210.

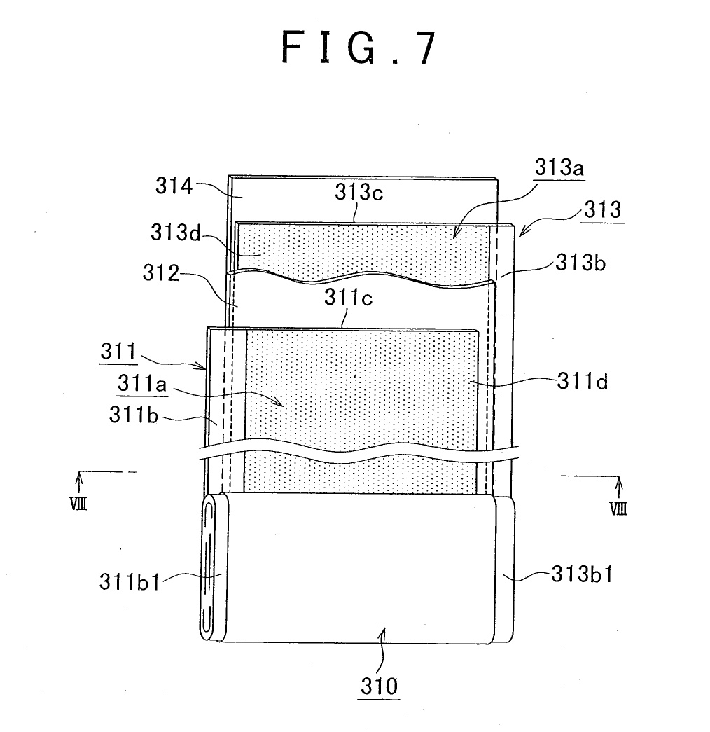

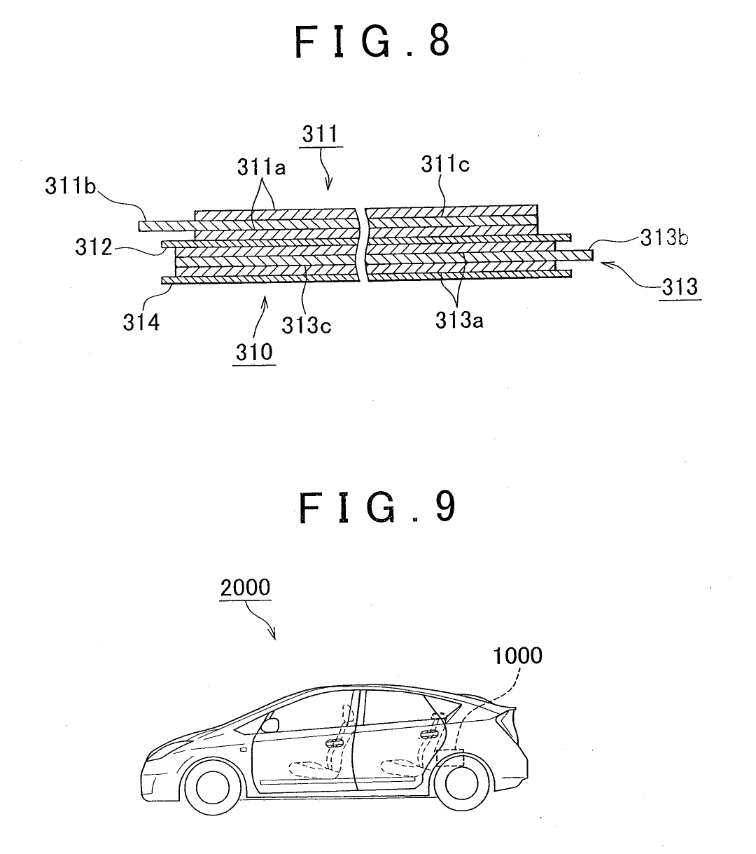

For example, as shown in FIG. 6, the lithium ion secondary battery 300 is configured so that a rolled electrode assembly 310 is accommodated in a rectangular metal battery case 300a. In the present embodiment, as shown in FIG. 7 and FIG. 8, the rolled electrode assembly 310 includes a positive electrode sheet 311 and a negative electrode sheet 313 as sheet-like electrodes. In addition, the rolled electrode assembly 310 includes a first separator 312 and a second separator 314 as sheet-like separators. Then, the positive electrode sheet 311, the first separator 312, the negative electrode sheet 313 and the second separator 314 are stacked in the stated order and rolled.

The positive electrode sheet 311 is formed so that an electrode material 311d that contains a positive electrode active material (which corresponds to the electrode active material 202 (see FIG. 5)) is applied on both surfaces of an aluminum foil (which corresponds to the current collector 210 (see FIG. 1 and FIG. 5)) as a current collector sheet 311c. The negative electrode sheet 313 is formed so that an electrode material 313d that contains a negative electrode active material (which corresponds to the electrode active material 202 (see FIG. 5)) is applied on both surfaces of a copper foil (which corresponds to the current collector 210 (see FIG. 1 and FIG. 5)) as a current collector sheet 313c. The separators 312 and 314 are membranes through which ionic substance is allowed to permeate. In the present embodiment, polypropylene microporous membranes are used as the separators 312 and 314.

In addition, in the present embodiment, the electrode materials 311d and 313d are respectively applied on one sides of the current collector sheets 311c and 313c in the widthwise direction. No electrode materials 311d and 313d are applied on the opposite edge portions of the current collector sheets 311c and 313c in the widthwise direction, respectively. A portion of the positive electrode sheet 311, at which the electrode material 311d is applied to the current collector sheet 311c, is termed a coated portion 311a. A portion of the negative electrode sheet 313, at which the electrode material 313d is applied to the current collector sheet 313c, is termed a coated portion 313a. A portion of the positive electrode sheet 311, at which no electrode material 311d is applied to the current collector sheet 311c is termed a non-coated portion 311b. A portion of the negative electrode sheet 313, at which no electrode material 313d is applied to the current collector sheet 313c, is termed a non-coated portion 313b.

FIG. 7 is a cross-sectional view in a widthwise direction, showing a state where the positive electrode sheet 311, the first separator 312, the negative electrode sheet 313 and the second separator 314 are stacked in the stated order. The coated portion 311a of the positive electrode sheet 311 and the coated portion 313a of the negative electrode sheet 313 face each other via the separator 312 or 314. As shown in FIG. 7 and FIG. 8, at both sides of the rolled electrode assembly 310 in a direction perpendicular to the rolled direction of the rolled electrode assembly 310 (rolling axis direction), the non-coated portion 311b of the positive electrode sheet 311 and the non-coated portion 313b of the negative electrode sheet 313 protrude from the separators 312 and 314. The non-coated portion 311b of the positive electrode sheet 311 forms a positive electrode current collector portion 311b1 of the rolled electrode assembly 310. The non-coated portion 313b of the negative electrode sheet 313 forms a negative electrode current collector portion 313b1 of the rolled electrode assembly 310.

As shown in FIG. 6, the battery case 300a has a positive electrode terminal 301 and a negative electrode terminal 303. The positive electrode terminal 301 is electrically connected to the positive electrode current collector portion 311b1 of the rolled electrode assembly 310. The negative electrode terminal 303 is electrically connected to the negative electrode current collector portion 313b1 of the rolled electrode assembly 310. An electrolyte is filled into the battery case 300a. The electrolyte may be formed of a nonaqueous electrolyte, such as a mixture solvent of diethyl carbonate, ethylene carbonate, or the like, containing an adequate amount of appropriate electrolyte salt (for example, lithium salt, such as LiPF6).

In the lithium ion secondary battery 300, during charging and discharging, the positive electrode active material and the negative electrode active material expand or contract. When charging and discharging are repeated, the positive electrode active material and the negative electrode active material repeatedly expand or contract. Because of expansion and contraction of the positive electrode active material and negative electrode active material, the electrode materials 311d and 313d may peel off from the respective current collector sheets 311c and 313c.

However, when the drying device 10 according to the present embodiment is used, as shown in FIG. 5, the percentage of the binder 204 is substantially maintained at the boundary portion with the current collector 210. Therefore, it is possible to provide the lithium ion secondary battery 300 (see FIG. 6 and FIG. 7) in which the electrode materials 311d and 313d are hard to peel off from the respective current collector sheets 311c and 313c.

In addition, in the lithium ion secondary battery 300, the battery performance changes depending on the components of the electrode materials 311d and 313d applied to the respective current collector sheets 311c and 313c. Therefore, in order to obtain desired battery performance, it is necessary to appropriately prepare the components of the electrode materials 311d and 313d. As shown in FIG. 5A and FIG. 5B, the drying device 10 according to the present embodiment is able to dry the electrode slurry 200 while substantially maintaining a state where the electrode slurry 200 is applied to the current collector 210. Therefore, in the drying process, the binder 204 clustering on one side or the electrode active material 202 clustering on one side is relieved. In addition, the ratio of components of the electrode slurry 200 supplied to the die 236 (see FIG. 2) should be appropriately prepared. In this way, the components of the electrode slurry 200 may be easily controlled.

In this way, as shown in FIG. 1, the drying device 10 according to the present embodiment includes the vibration imparting devices 16 for imparting vibrations to the corresponding guide rollers 14a arranged in the drying furnace 12. Therefore, as shown in FIG. 5A and FIG. 5B, it is possible to dry the electrode slurry 200 while substantially maintaining a state where the electrode slurry 200 is applied to the current collector 210, so the percentage of the binder 204 may be maintained at the boundary portion between the current collector 210 and the electrode slurry 200. By so doing, it is possible to provide the lithium ion secondary battery 300 (see FIG. 6 and FIG. 7) in which the electrode materials 311d and 313d are hard to peel off from the respective current collector sheets 311c and 313c.

The electrode materials 311d and 313d are hard to peel off from the respective current collector sheets 311c and 313c, so the above lithium ion secondary battery 300 is suitable as a vehicle secondary battery that is repeatedly charged and discharged and that requires high durability. A plurality of the lithium ion secondary batteries 300 are combined to constitute a battery pack 1000, and the battery pack 1000 is mounted as a power supply for a vehicle 2000 shown in FIG. 9. The aspect of the invention contributes to stability of performance of the vehicle battery and extension of the service life. A specific example of the vehicle 2000 may be an automobile equipped with an electric motor, such as a hybrid automobile, an electric automobile and a fuel cell automobile. The battery pack 1000 may be applied to such vehicles as a power supply (secondary battery).

The drying device according to the embodiment of the invention is described above; however, the aspect of the invention is not limited to the above described embodiment.

As shown in FIG. 1 and FIG. 2, the drying device 10 desirably includes: the drying furnace 12; the plurality of guide rollers 14 that are arranged in the drying furnace 12 and that transport the sheet-like current collector 210; and the vibration imparting device 16 that is provided for at least part of the plurality of guide rollers 14 (guide rollers 14a) arranged in the drying furnace 12 and that imparts vibrations to the at least part of the guide rollers 14 (guide rollers 14a). In this case, the specific configurations of the drying furnace, guide roller and vibration imparting device are not limited to the above described embodiment.

In the above described embodiment, for example, as shown in FIG. 1, the vibration imparting device 16 is provided for each of the guide rollers 14a provided at the preliminary drying portion 12a among the plurality of guide rollers 14 arranged in the drying furnace 12. In this way, in the drying furnace 12, the vibration imparting device 16 may be provided for each of the guide rollers 14a provided in the first half region within the region in which the sheet-like current collector 210 is dried. In addition, the drying device is not limited to the above configuration, the vibration imparting device 16 may be provided for each of all the guide rollers 14 provided in the drying furnace 12. Thus, for example, the vibration imparting device 16 may be provided for each of the guide rollers 14 provided at the regular drying portion 12b. In addition, the drying device is not limited to the configuration that the vibration imparting device 16 is provided for each of all the guide rollers 14a provided at the preliminary drying portion 12a; instead, the vibration imparting device 16 may be provided for each of part of the guide rollers 14a provided at the preliminary drying portion 12a.

In addition, vibrations imparted by the vibration imparting device 16 to the corresponding guide roller 14a may be vibrations that can suppress movement of the electrode active material 202 or the binder 204 in the electrode slurry 200 applied to the current collector 210 transported inside the drying furnace 12. The frequency and the amplitude may be appropriately set so as to obtain the above advantageous effect. For example, the vibration imparting device 16 desirably imparts vibrations having a frequency of 15 kHz or above, more desirably, 20 kHz or above, to the corresponding guide roller 14a. The vibrations can appropriately suppress movement of the electrode active material 202 or the binder 204 in the electrode slurry 200. In addition, when vibrations having a frequency of ultrasonic level (for example, 15 kHz or above, more desirably, 20 kHz or above) are imparted to the guide rollers 14a, sound attended with vibrations may be suppressed to a lesser degree.

In addition, the upper limit of the frequency of vibrations imparted to the guide rollers 14a is desirably set so as to be able to suppress movement of the electrode active material 202 or the binder 204 in the electrode slurry 200 applied to the current collector 210. For example, the upper limit of the frequency of imparted vibrations may be 80 kHz or below or may be 50 kHz or below. In addition, the frequency of vibrations imparted to the guide rollers 14a is desirably set to an appropriate frequency depending on the electrode slurry 200 applied to the current collector 210.

In addition, in the present embodiment, the plurality of guide rollers 14 are arranged along the transport path of the current collector 210 in the drying furnace 12, and the guide rollers 14a equipped with the vibration imparting device 16 are desirably arranged at appropriate intervals. In this case, in consideration of the transport speed of the current collector 210, the frequency imparted to the guide rollers 14a, and the like, the guide rollers 14a are desirably arranged at appropriate intervals. Note that vibrations that can prevent the electrode active material 202 in the electrode slurry 200 from settling out or the binder 204 in the electrode slurry 200 from moving to the upper layer of the electrode slurry 200 are desirably imparted to the current collector 210. In this case, for example, a distance by which the current collector 210 advances per vibration is desirably regulated appropriately.

For the above regulation, where the transport speed of the current collector 210 is V (m/s) and the frequency imparted to the guide rollers 14a is f (Hz), when the interval x (m) of the guide rollers 14a is set to x=(V/f), one vibration per meter is imparted to the transported current collector 210. For example, according to the findings of the inventors, obtained through various studies, when the current collector 210 is transported while appropriate tension is imparted to the current collector 210, the interval x (m) of the guide rollers 14a may be, for example, set so that 0.001 (V/f)≦x≦5 (V/f) (more desirably, 0.01 (V/f)≦x≦2 (V/f)). The above setting may be performed, for example, by regulating the transport speed V of the current collector 210, the frequency f imparted to the guide rollers 14a and the interval x of the guide rollers 14a equipped with the vibration imparting device 16. By so doing, vibrations that can prevent the electrode active material 202 in the electrode slurry 200 from settling out or the binder 204 in the electrode slurry 200 from moving to the upper layer of the electrode slurry 200 may be imparted to the current collector 210. The above advantageous effect may be almost obtained irrespective of the type of the electrode slurry 200.

Here, where x is lower than or equal to 2 (V/f), at least a vibration per 2 meters may be imparted to the transported current collector 210. By so doing, it is possible to prevent an excessive increase in distance by which the current collector 210 advances per vibration. In addition, when x is higher than 0.01 (V/f), the distance by which the current collector 210 advances may be 1 cm or above per vibration. By so doing, it is possible to prevent an excessive decrease in distance by which the current collector 210 advances per vibration. Note that appropriate vibrations are desirably imparted to the transported current collector 210, and the transport speed V of the current collector 210, the frequency f imparted to the guide rollers 14a and the interval x of the guide rollers 14a equipped with the vibration imparting device 16 may be regulated so as to fall outside the range of 0.01 (V/f)≦x≦2 (V/f).

For example, when the transport speed of the transported current collector 210 is increased, the frequency imparted to the guide rollers 14a is desirably increased or the interval of the guide rollers 14a equipped with the vibration imparting device 16 is desirably reduced. In addition, a controller (not shown) that regulates the frequency imparted to the guide rollers 14a in response to the transport speed of the transported current collector 210 may be provided.

In addition, a particulate material contained in the electrode slurry 200 and a material used for the current collector 210 are not limited to the above embodiment. The electrode slurry 200, for example, desirably contain various types of electrode active material 202, binder 204 (bonding material), conductive material, and the like. In addition, for example, various materials used for a current collector electrode of a battery may be used for the current collector 210.

In addition, as shown in FIG. 3, as the guide roller 14a applicable to the drying device 10, the vibration imparting device-equipped guide roller 14, in which the rolling shaft 46 is assembled to the fixed shaft 42 via the bearings 44 and the vibrator 16a is attached to the fixed shaft 42, is illustrated; however, the configuration of the vibration imparting device-equipped guide roller 14a is not limited to the above embodiment.

In addition, the drying device 10 may be applied to a manufacturing method for an electrode sheet in which a coating containing an electrode active material is formed on a sheet-like current collector. That is, as shown in FIG. 2, the manufacturing method for an electrode sheet in which a coating containing an electrode active material is formed on a sheet-like current collector may include an electrode slurry application process (s1) of applying the electrode slurry 200 containing the electrode active material 202 to the sheet-like current collector 210; and a drying process (s2) of drying the electrode slurry 200 while imparting vibrations to the current collector 210 to which the electrode slurry 200 is applied in the electrode slurry application process (s1). The manufacturing method for an electrode sheet may also be applied to manufacturing an electrode sheet of any of a positive electrode and a negative electrode.

1. A drying device characterized by comprising:
a drying furnace;
a plurality of guide rollers that are arranged in the drying furnace and that transport a sheet-like current collector; and
a vibration imparting device that is provided for at least part of the plurality of guide rollers arranged in the drying furnace and that imparts vibrations to the at least part of the plurality of guide rollers.

2. The drying device according to claim 1, wherein vibrations imparted to the at least part of the plurality of guide rollers are ultrasonic vibrations.

3. The drying device according to claim 1, wherein the vibration imparting device imparts vibrations of 15 kHz or above to the at least part of the plurality of guide rollers.

4. The drying device according to claim 3, wherein the vibration imparting device imparts vibrations of 20 kHz or above to the at least part of the plurality of guide rollers.

5. The drying device according to claim 3 or 4, wherein the vibration imparting device imparts vibrations of 80 kHz or below to the at least part of the plurality of guide rollers.

6. The drying device according to any one of claims 3 to 5, wherein the vibration imparting device imparts vibrations of 50 kHz or below to the at least part of the plurality of guide rollers.

7. The drying device according to any one of claims 1 to 6, wherein the vibration imparting device is provided for part of the plurality of guide rollers provided in a first half region within a region in which the sheet-like current collector is dried in the drying furnace.

8. The drying device according to claim 7, wherein the first half region in the drying furnace is set at a temperature lower than that of a second half region within the region in which the sheet-like current collector is dried in the drying furnace.

9. The drying device according to any one of claims 1 to 8, wherein the vibration imparting device includes a vibrator, each guide roller has a fixed shaft and a rolling shaft that is assembled to the fixed shaft via a bearing, and the vibrator is attached to the fixed shaft.

10. A guide roller equipped with a vibration imparting device, comprising a fixed shaft and a rolling shaft that is assembled to the fixed shaft via a bearing, wherein a vibrator is attached to the fixed shaft.

11. A manufacturing method for an electrode sheet in which a coating that contains an electrode active material is formed on a sheet-like current collector, characterized by comprising:
an electrode slurry application step of applying electrode slurry containing the electrode active material to the sheet-like current collector; and
a drying step of drying the electrode slurry while imparting vibrations to the current collector to which the electrode slurry is applied in the electrode slurry application step.

12. The manufacturing method for an electrode sheet according to claim 11, wherein
the drying step includes a first step and a second step having different drying temperatures, and
the drying temperature of the first step is lower than that of the second step.

13. The manufacturing method for an electrode sheet according to claim 11 or 12, wherein the vibrations imparted to the current collector in the drying step are ultrasonic vibrations.
